(19) United States
(12) Patent Application Publication
(10) Pub. No.: US 2023/0305996 A1
(43) Pub. Date: Sep. 28, 2023

(54) FILE STORAGE MANAGEMENT METHOD AND SYSTEM, DEVICE, AND MEDIUM

(71) Applicant: SUZHOU INSPUR INTELLIGENT TECHNOLOGY CO., LTD., Suzhou, Jiangsu (CN)

(72) Inventors: Aoyu MA, Suzhou, Jiangsu (CN); Kaiyuan QI, Suzhou, Jiangsu (CN); Bao MA, Suzhou, Jiangsu (CN)

(21) Appl. No.: 18/020,812

(22) PCT Filed: Jun. 7, 2021
(86) PCT No.: PCT/CN2021/096408

§ 371 Date: Feb. 10, 2023

(30) Foreign Application Priority Data
Aug. 14, 2020 (CN) 202010821009.4

(51) Int. Cl. G06F 16/11; G06F 16/182

(52) U.S. Cl. CPC G06F 16/122; G06F 16/1827

(57) ABSTRACT

Disclosed is a file storage management method. The method includes the following steps: sending a mount request to a management platform by using an agent service, and receiving a mount parameter returned by the management platform; recording the mount parameter into a configuration file of the agent service; determining, according to the configuration file, the address of a file storage to be mounted; and mounting a file system in response to a normal heartbeat between an address of a cloud host and the address of the file storage to be mounted. Further disclosed are a system, a computer device, and a readable storage medium.

This application claims priority to Chinese Patent Application No. 202010821009.4, filed on Aug. 14, 2020 in China National Intellectual Property Administration and entitled “File Storage Management Method and System, Device, and Medium”, which is hereby incorporated by reference in its entirety.

### FIELD

The present disclosure relates to a field of NFS (Network File System), in particular to a file storage management method and system, a device, and a storage medium.

### BACKGROUND

On a cloud platform operating system, a user can easily create a shared file storage through a Manila service, and finally complete a creation of an underlying shared file directory under a drive of a corresponding driver. If a file storage is desired to be used in a cloud host, the cloud host shall be entered. A Linux (an operating system) system manually executes a mount command and mounts an export path of the file storage to a local directory before use. A Windows (an operating system) system requires manual mapping of a network driver to a partition and requires account password authentication before use. In addition, if an abnormality such as network interruption or restart of the cloud host occurs, the abnormality needs to be manually repaired, and the export path of the file storage needs to be remounted.

With an increase of cloud hosts in a cloud platform, increasing users may mount an export path of a same file storage, so a cloud platform administrator cannot control or know at present which cloud hosts mount the export path of the file storage, causing the file storage to be unmanageable.

### SUMMARY

In view of this, in order to overcome at least one aspect of the above problems, some embodiments of the present disclosure provide a file storage management method, including the following steps:
sending a mount request to a management platform by using an agent service, and receiving a mount parameter returned by the management platform;
recording the mount parameter into a configuration file of the agent service;
determining, according to the configuration file, an address of a file storage to be mounted; and
mounting a file system in response to a determination that a heartbeat between an address of a cloud host and the address of the file storage to be mounted is normal.

In some embodiments, the sending a mount request to a management platform by using an agent service, and receiving a mount parameter returned by the management platform further includes:
receiving an export path of the file storage returned by the management platform based on a least connections algorithm.

In some embodiments, the method further includes:
detecting a mount state regularly in response to a determination that the file system is successfully mounted; and
remounting, according to the configuration file, in response to an abnormal mount state.

In some embodiments, the performing, according to the configuration file, remount in response to an abnormal mount state further includes:
determining whether the heartbeat between the address of the cloud host and the address of the file storage to be mounted is normal; and
remounting, according to the configuration file, in response to a determination that the heartbeat between the address of the cloud host and the address of the file storage to be mounted returns to normal.

In some embodiments, the method further includes:
modifying the configuration file and interrupting a connection with the file storage by the agent service in response to a determination that an unmount instruction delivered by the management platform is received.

In some embodiments, the method further includes:
recording, by the management platform, the export path, a mounted cloud host, and mount time into a table.

In some embodiments, the sending a mount request to a management platform by using an agent service, and receiving a mount parameter returned by the management platform further includes:
in response to a determination that the mount request is received, selecting, by the management platform, an export path of the file storage based on the least connections algorithm by using a Manila service, and recording the mount parameter including the export path of the file storage into the table;
forwarding, by the Manila service, the export path to a Nova service; and
returning, by the Nova service, the export path to the agent service on the cloud host.

Based on the same inventive concept, according to another aspect of the present disclosure, some embodiments of the present disclosure further provide a file storage management system, including:
a sending module, configured to send a mount request to a management platform by using an agent service, and receive a mount parameter returned by the management platform;
a recording module, configured to record the mount parameter into a configuration file of the agent service;
a determination module, configured to determine, according to the configuration file, an address of a file storage to be mounted; and
a mount module, configured to mount a file system in response to a determination that a heartbeat between the address of a cloud host and the address of the file storage to be mounted is normal.

Based on the same inventive concept, according to another aspect of the present disclosure, some embodiments of the present disclosure further provide a computer device, including:
at least one processor; and
a memory storing a computer program executable on the processor, characterized in that the processor executes the steps of any file storage management method as described above when executing the program.

Based on the same inventive concept, according to another aspect of the present disclosure, some embodiments of the present disclosure further provide a computer-readable storage medium storing a computer program that, when executed by a processor, executes the steps of any file storage management method as described above.

The present disclosure has one of the following beneficial technical effects: by means of the solution provided by the present disclosure, the management capability of a management platform for a file system mounted on a cloud host may be improved, and a file storage may be conveniently used without any operation of a user on the cloud host.

### BRIEF DESCRIPTION OF THE DRAWINGS

In order to describe the technical solutions in the embodiments of the present disclosure or in the prior art more clearly, drawings required to be used in the illustration of the embodiments or the prior art will be briefly introduced below. Apparently, the drawings in the illustration below are only some embodiments of the present application. Those ordinarily skilled in the art also may obtain other drawings according to the provided drawings without creative work.

FIG. 1 is a schematic flow chart of a file storage management method according to some embodiments of the present disclosure;

FIG. 2 is a flow block diagram of mount/unmount of a file storage by an agent service according to some embodiments of the present disclosure;

FIG. 3 is a flow block diagram of mount/unmount of the file storage by the management platform according to some embodiments of the present disclosure;

FIG. 4 is a schematic structural diagram of a file storage management system according to some embodiments of the present disclosure;

FIG. 5 is a schematic structural diagram of a computer device according to some embodiments of the present disclosure; and

FIG. 6 is a schematic structural diagram of a computer-readable storage medium according to some embodiments of the present disclosure.

### DETAILED DESCRIPTION

In order to make objectives, technical solutions and advantages of the present disclosure clearer, embodiments of the present disclosure will be further described in detail below in conjunction with some embodiments and the accompanying drawings.

It should be noted that Manila in the embodiments of the present disclosure provides a file storage service for a cloud platform OpenStack (an open source cloud computing management platform project). File storage NFS is a network file system, and the network file system is one of file systems supported by FreeBSD (a UNIX operating system). By using NFS, users and programs may access files on remote systems as they access local files.

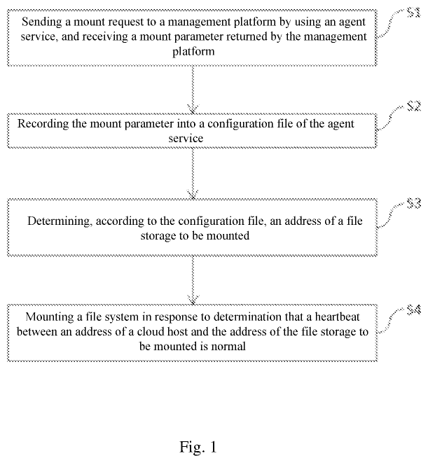

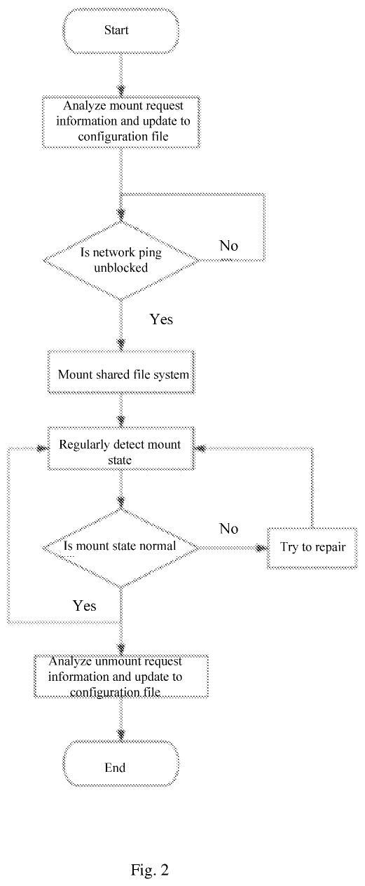

According to one aspect of the present disclosure, some embodiments of the present disclosure provide a file storage management method, as shown in FIG. 1 and FIG. 2. The method may include following steps:

S1, a mount request is sent to a management platform by using an agent service, and a mount parameter returned by the management platform are received;

S2, the mount parameter is recorded into a configuration file of the agent service; S3, an address of a file storage to be mounted is determined according to the configuration file; and

S4, a file system is mounted in response to a determination that a heartbeat between an address of a cloud host and the address of the file storage to be mounted is normal.

By means of a solution provided by the present disclosure, a management capability of the management platform for the file system mounted on a cloud host may be improved, and the file storage may be conveniently used without any operation of a user on the cloud host.

In some embodiments, step S1 that the mount request is sent to the management platform by using the agent service, and the mount parameter returned by the management platform are received further includes:

Export paths of the file storage returned by the management platform based on a least connections algorithm are received.

In some embodiments, step S1 that the mount request is sent to the management platform by using the agent service, and the mount parameter returned by the management platform are received may further include:
In response to a determination that receiving the mount request, the management platform selects the export path of the file storage based on the least connections algorithm by using a Manila service, and records the mount parameter including the export path of the file storage into the table;
The Manila service forwards the export path to a Nova (a component of OpenStack, which provides a computing service in OpenStack) service; and
The Nova service returns the export path to the agent service on the cloud host.

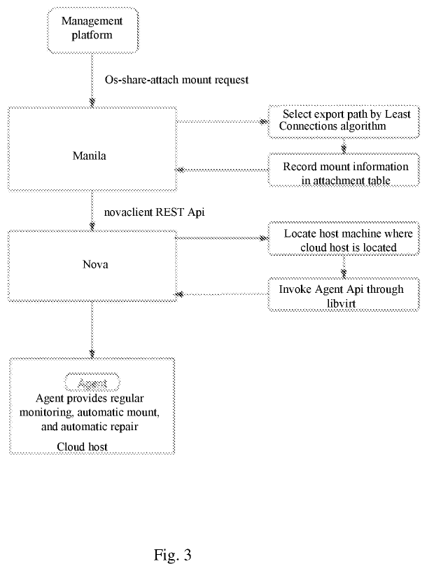

In some embodiments, as shown in FIG. 3, within the management platform, upon receiving the mount request sent by the cloud host, the mount request (os-share-attach) is transmitted to the Manila service through a Manila REST (Representational State Transfer) API (Application Programming Interface), the Manila service automatically obtain an export path of the file storage by using a least connections algorithm, then the Nova service is invoked to invoke an API of an agent service in the cloud host by means of a libvirt (an open source API, a background program, and a management tool for managing a virtual platform) of a host machine where the cloud host is located, the API forwards the request to the agent service (Agent) in the cloud host, and the Agent records mount information (export path) to a configuration file of the agent service in the cloud host.

It should be noted that, because the file storage usually has a plurality of export paths, if user's manual mount is required, it is difficult to achieve a load balance among the export paths. Therefore, a mount point mounted least may be selected by using the least connections algorithm for mounting, thereby ensuring a load balance among the export paths.

In some embodiments, S4 that the file system is mounted in response to a normal heartbeat between the address of a cloud host and the address of the file storage to be mounted is as follows: a mount command is executed after the mount parameter is saved by the Agent, where a linux system may execute the mount command, and a Windows system implements mapping into a network driver by invoking a dynamic link library of windows sdk (software development kit).

In some embodiments, the method further includes:

The management platform records the export path, a mounted cloud host, and mount time into a table.

In some embodiments, as shown in FIG. 3, an attments (abbreviation of attachments) table recording mount information may be added in the Manila service, an os-share-attach interface is extended, and parameters such as export paths (export_path) and mount points (mountpoint) may be transmitted to the interface. The attments table records information such as the mount time, the export paths, and mount points (cloud hosts), which helps a project administrator to view. In addition, after a cloud host mounts the file storage successfully, corresponding information of the cloud host mounted with the file storage, that is, recorded attachments table information, may be displayed by extending the original API ({project_id}/detail) interface of Manila when the file storage is viewed, whereby the Manila service may save mount information in a database and count the number of cloud hosts connected to each export path, so as to meet the requirements of the least connections algorithm for load balancing.

In some embodiments, the method further includes:

A mount state is detected regularly in response to a determination that the file system is successfully mounted; and

Remount is performed according to the configuration file in response to an abnormal mount state.

In some embodiments, as shown in FIG. 2, after the mounting succeeds, the Agent starts a time thread (30 s by default), and a mount directory is analyzed through a mount command, so as to regularly detect the mount state of the shared file storage. When it is detected that the mount state is abnormal, because the Agent has saved mount parameters in the configuration file, remount may be tried according to the parameters in the configuration file. The Linux system supports remount and may complete automatic repair, and the Windows system may also complete remapping.

In some embodiments, the step that remount is performed according to the configuration file in response to the abnormal mount state further includes:
Whether the heartbeat between the address of the cloud host and the address of the file storage to be mounted is normal is determined; and
Remount is performed according to the configuration file in response to a determination that the heartbeat between the address of the cloud host and the address of the file storage to be mounted returns to normal.

In some embodiments, if a network ping (packet internet groper) between the address of the cloud host and the address of the file storage is blocked or the heartbeat is abnormal, the Agent will not try to mount all the time, but try to remount when the heartbeat is normal. After the cloud host restarts, the Agent starts and mounts the file storage automatically.

In some embodiments, the method further includes: The agent service modifies the configuration file and interrupts a connection with the file storage in response to a determination that receiving an unmount instruction delivered by the management platform.

In some embodiments, as shown in FIG. 2, the administrator on the management platform may select, by viewing attachments information, a cloud host to unmount, which may be implemented by extending the Manila interface (os-share-deattach), finding attment (abbreviation of attachment) information of the cloud host corresponding to the file storage, recording unmount time, and marking the cloud host as deleted. After receiving an unmount request, the Agent in the cloud host modifies the configuration file and interrupts the connection with the underlying file storage, and the Agent releases monitoring on the file storage.

In some embodiments, the file storage may be created by the management platform, and the cloud host may be created by using a mirror image with the Agent, or the Agent may be manually installed after the cloud host is created. An installation package of different Agents based on a Windows system and a Linux system may be provided, and at the same time, a unified C++ API may be provided to the outside. Service-oriented programming may be implemented on the Windows system, and a light-weighted application may be realized based on a Windows Service and embedded in the Windows system to self-start. On the Linux system, the Agent is registered as a service unit managed by systemd (system daemon), and a boot service is self-started and embedded into a Linux image. The Agent realizes functions such as regular monitoring (by modifying the configuration file), automatic mount, and automatic repair of the shared file storage.

By means of the solution provided by the present disclosure, the file storage may be directly mounted to a cloud host, and export paths of the file storage may be automatically obtained. The file storage usually has a plurality of export paths, and if user's manual mount is required, it is difficult to achieve a load balance among the export paths. Therefore, a mount point mounted least may be selected by using the least connections algorithm for mounting, thereby ensuring a load balance among the export paths. A cloud platform sends a mount request to a Manila service through a Manila REST API and records mount information; then the Nova service (novaclient, a client of Nova) is invoked to forward the request to an Agent in the cloud host, and the Agent records request information to a configuration file. In order to ensure a normal mount state of the file storage, the Agent not only executes a mount action, but also implements a regular detection mechanism. Under the condition that the heartbeat between the addresses of the local host and a remote file storage is normal, the Agent queries the mount state regularly. When the mount state is abnormal, the Agent will try to remount and repair, so as to ensure the high availability of the file storage. If the addresses of the local host and the remote file storage are not connected, the Agent will not try to mount all the time, but try to remount when the heartbeat is normal. After the cloud host restarts, the Agent starts and mounts the file storage automatically. After successful mount, the Manila service saves mount information to a database, and counts a number of cloud hosts connected to each export path, so as to meet the requirements of the least connections algorithm for load balancing. When the file storage is unmounted, the project administrator may directly select a corresponding file storage which may display all the mounted cloud hosts, and select a cloud host to unmount. During unmount, the Agent inside the cloud host synchronously changes the configuration file and no longer monitors the file storage, and the cloud platform deletes the mount information. In this way, a user may easily use the shared file storage without any operation, and the file storage management capability of a project administrator on the management platform is also improved.

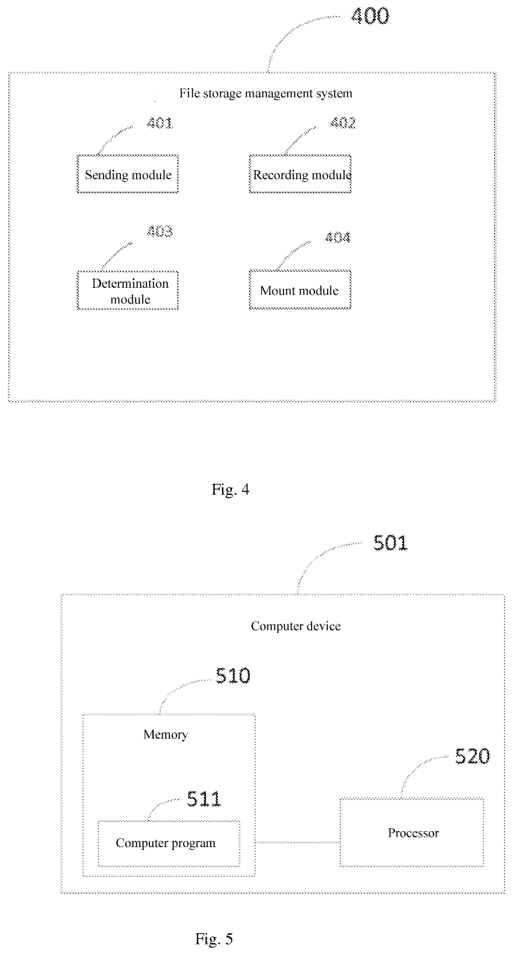

Based on the same inventive concept, according to another aspect of the present disclosure, some embodiments of the present disclosure further provide a file storage management system 400, as shown in FIG. 4, including:
a sending module 401, configured to send a mount request to a management platform by using an agent service, and receive a mount parameter returned by the management platform;
a recording module 402, configured to record the mount parameter into a configuration file of the agent service;
a determination module 403, configured to determine, according to the configuration file, an address of a file storage to be mounted; and
a mount module 404, configured to mount a file system in response to a determination that a heartbeat between an address of a cloud host and the address of the file storage to be mounted is normal.

Based on the same inventive concept, according to another aspect of the present disclosure, as shown in FIG. 5, some embodiments of the present disclosure further provide a computer device 501, including:
at least one processor 520; and
a memory 510 storing a computer program 511 executable on the processor, where the processor 520 executes the steps of any file storage management method as described above when executing the program.

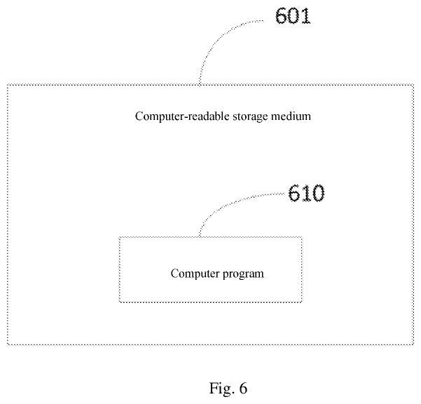

Based on the same inventive concept, according to another aspect of the present disclosure, as shown in FIG. 6, some embodiments of the present disclosure further provide a computer-readable storage medium 601 storing computer program instructions 610 that, when executed by a processor, execute the steps of any file storage management method as described above.

Finally, it should be noted that those of ordinary skill in the art may understand that all or part of the flows of implementing the methods of the foregoing embodiments may be completed by a computer program instructing relevant hardware, the program may be stored in a computer-readable storage medium, and when executed, the program may include the flow of the embodiment of each method above.

Further, it should be understood that the computer-readable storage medium (for example, a memory) herein may be a transitory memory or a non-transitory memory, or may include both the transitory memory and the non-transitory memory.

Those skilled in the art will also appreciate that various exemplary logic blocks, modules, circuits, and algorithm steps described in conjunction with the disclosure herein may be implemented as electronic hardware, computer software, or a combination of both. In order to clearly illustrate the interchangeability of hardware and software, various illustrative components, blocks, modules, circuits, and steps has been generally described in terms of their functions. Whether the functions are implemented as software or hardware depends on applications and design constraints imposed on an entire system. Those skilled in the art may implement the functions in various ways for each particular application, but such implementation decisions should not be interpreted as leading to a departure from the scope of the embodiments of the present disclosure.

Described above are exemplary embodiments of the present disclosure. However, it should be noted that various changes and modifications may be made without departing from the scope of the embodiments of the present disclosure as defined by the claims. The functions, steps and/or operations of the method claims according to the disclosed embodiments described herein do not need to be performed in any order. In addition, although the elements disclosed in the embodiments of the present disclosure may be described or required in individual forms, they may also be understood as plural unless explicitly limited to a singular number.

It should be understood that, as used herein, the singular form “a” is intended to include a plural form as well unless the context clearly supports exceptions. It should also be understood that “and/or” as used herein means any and all possible combinations including one or more items associatively listed.

The foregoing serial numbers of the embodiments of the present disclosure are disclosed for description only and do not represent the advantages and disadvantages of the embodiments.

Those of ordinary skill in the art may understand that all or some of the steps of the foregoing embodiments may be completed by hardware, or may be completed by a program instructing relevant hardware. The program may be stored in a computer-readable storage medium. The storage medium may be a read-only memory, a magnetic disk, an optical disk, or the like.

It should be understood by those of ordinary skill in the art that the discussion of any of the above embodiments is exemplary only and is not intended to imply that the scope of the embodiments of the present disclosure (including the claims) is limited to these examples. Under the idea of the embodiments of the present disclosure, the technical features in the above embodiments or different embodiments may be combined, and there are many other variations in different aspects of the embodiments of the present disclosure as above, which are not provided in detail for brevity. Therefore, any omissions, modifications, equivalent substitutions, improvements, and the like made within the spirit and principles of the embodiments of the present disclosure should be included within the scope of protection of the embodiments of the present disclosure.

1. A file storage management method, comprising following steps:
sending a mount request to a management platform by using an agent service, and receiving a mount parameter returned by the management platform;
recording the mount parameter into a configuration file of the agent service;
determining, according to the configuration file, an address of a file storage to be mounted; and
mounting a file system in response to a determination that a heartbeat between an address of a cloud host and the address of the file storage to be mounted is normal.

2. The method according to claim 1, wherein the sending a mount request to a management platform by using an agent service, and receiving a mount parameter returned by the management platform comprises:
receiving an export path of the file storage to be mounted returned by the management platform based on a least connections algorithm.

3. The method according to claim 1, further comprising:
detecting a mount state regularly in response to a determination that the file system is successfully mounted; and
remounting, according to the configuration file, in response to an abnormal mount state.

4. The method according to claim 3, wherein the remounting, according to the configuration file, in response to an abnormal mount state comprises:
determining whether the heartbeat between the address of the cloud host and the address of the file storage to be mounted is normal; and
remounting, according to the configuration file, in response to a determination that the heartbeat between the address of the cloud host and the address of the file storage to be mounted returns to normal.

5. The method according to claim 1, further comprising:
modifying the configuration file and interrupting a connection with the file storage to be mounted by the agent service in response to a determination that an unmount instruction delivered by the management platform is received.

6. The method according to claim 2, further comprising:
recording, by the management platform, the export path, a mounted cloud host, and mount time into a table.

7. The method according to claim 1, wherein the sending a mount request to a management platform by using an agent service, and receiving a mount parameter returned by the management platform comprises:
in response to a determination that the mount request is received, selecting, by the management platform, an export path of the file storage to be mounted based on a least connections algorithm by using a Manila service, and recording the mount parameter comprising the export path of the file storage to be mounted into a table;
forwarding, by the Manila service, the export path to a Nova service; and
returning, by the Nova service, the export path to the agent service on the cloud host.

8. (canceled)

9. A computer device, comprising:
at least one processor; and
a memory storing a computer program executable on the at least one processor, wherein the at least one processor executes the computer program to:
send a mount request to a management platform by using an agent service, and receive a mount parameter returned by the management platform;
record the mount parameter into a configuration file of the agent service;
determine, according to the configuration file, an address of a file storage to be mounted; and
mount a file system in response to a determination that a heartbeat between an address of a cloud host and the address of the file storage to be mounted is normal.

10. A non-transitory storage medium storing a computer program, wherein the computer program is executed by a processor, and upon execution by the processor, is configured to cause the processor to:
send a mount request to a management platform by using an agent service, and receive a mount parameter returned by the management platform;
record the mount parameter into a configuration file of the agent service;
determine, according to the configuration file, an address of a file storage to be mounted; and
mount a file system in response to a determination that a heartbeat between an address of a cloud host and the address of the file storage to be mounted is normal.

11. The method according to claim 2, wherein the sending a mount request to a management platform by using an agent service, and receiving a mount parameter returned by the management platform further comprises:
transmitting the mount request to a Manila service through a Manila representational state transfer interface to make the Manila service return the export path based on the least connections algorithm.

12. The method according to claim 6, wherein the recording, by the management platform, the export path, a mounted cloud host, and mount time into a table comprises:
extending an os-share-attach interface; and
recording, by the os-share-attach interface, the export path, the mounted cloud host, and the mount time into the table.

13. The method according to claim 3, wherein the detecting a mount state regularly in response to a determination that the file system is successfully mounted comprises:
starting a time thread to detect the mount state regularly.

14. The method according to claim 3, wherein the detecting a mount state regularly in response to a determination that the file system is successfully mounted further comprises:
analyzing a mount directory through a mount command to detect the mount state regularly.

15. The method according to claim 4, wherein after the determining whether the heartbeat between the address of the cloud host and the address of the file storage to be mounted is normal, the method further comprises:
stopping mounting in response to a determination that the heartbeat between the address of the cloud host and the address of the file storage to be mounted is abnormal.

16. The method according to claim 1, wherein after the mounting a file system in response to a determination that a heartbeat between an address of a cloud host and the address of the file storage to be mounted is normal, the method further comprises:
mounting the file storage to be mounted automatically in response to a determination that the cloud host is restarted.

17. The method according to claim 4, wherein before the sending a mount request to a management platform by using an agent service, and receiving a mount parameter returned by the management platform, the method further comprises:
creating the cloud host by using a mirror image with the agent service.

18. The method according to claim 5, wherein after the modifying the configuration file and interrupting a connection with the file storage to be mounted by the agent service in response to a determination that an unmount instruction delivered by the management platform is received, the method further comprises:
releasing, by the agent service, monitoring on the file storage to be mounted.

19. The method according to claim 1, wherein after the mounting a file system in response to a determination that a heartbeat between an address of a cloud host and the address of the file storage to be mounted is normal, the method further comprises:
saving mount information to a database in response to a determination that the file system is successfully mounted.

20. The method according to claim 2, wherein after the mounting a file system in response to a determination that a heartbeat between an address of a cloud host and the address of the file storage to be mounted is normal, the method further comprises:
counting a number of connected cloud hosts corresponding to the export path in response to a determination that the file system is successfully mounted.

21. The method according to claim 1, wherein after the mounting a file system in response to a determination that a heartbeat between an address of a cloud host and the address of the file storage to be mounted is normal, the method further comprises:
displaying all mounted cloud host corresponding to a file storage to be unmounted; and
unmounting a cloud host to be unmounted of the all mounted cloud host.
